(19) United States
(12) Patent Application Publication
(10) Pub. No.: US 2014/0309793 A1
(43) Pub. Date: Oct. 16, 2014

(54) METHOD AND APPARATUS OF SELF-ORGANIZING ACTUATION AND CONTROL

(71) Applicant: GENERAL CYBERNATION GROUP, INC., Rancho Cordova, CA (US)

(72) Inventors: George Shu-Xing Cheng, Folsom, CA (US); Steven L. Mulkey, Cameron Park, CA (US); Qiang Wang, Sacramento, CA (US)

(73) Assignee: GENERAL CYBERNATION GROUP, INC., Rancho Cordova, CA (US)

(21) Appl. No.: 14/169,064

(22) Filed: Jan. 30, 2014

Related U.S. Application Data
(60) Provisional application No. 61/812,143, filed on Apr. 15, 2013.

(51) Int. Cl. G05B 13/04; G05D 7/06

(52) U.S. Cl. CPC G05B 13/048; G05D 7/0629
USPC 700/282; 700/47; 700/44

(57) ABSTRACT

A Self-Organizing Process Control Architecture is introduced with a Sensing Layer, Control Layer, Actuation Layer, Process Layer, as well as Self-Organizing Sensors (SOS), Self-Organizing Actuators (SOA), and Self-Organizing Actuation and Control Units (SOACU). The method and apparatus of SOA and SOACU for process control are presented. A control system as a case example for a gas mixing process is described using the unique SOA and SOACU approaches. A 2x1 Robust MFA (Model-Free Adaptive) controller as a key component of the SOACU is also disclosed.

This application claims priority to U.S. Provisional Application No. 61/812,143 filed on Apr. 15, 2013, which is herein incorporated by reference.

This invention was made with government support under SBIR grant DE-SC0008235 and SBIR grant DE-FG02-08ER84944 awarded by the U.S. Department of Energy. The government has certain rights to the invention.

The subject of this patent relates to sensing, actuation, and automatic control of physical processes including industrial processes, equipment, facilities, buildings, devices, boilers, valve positioners, motion stages, drives, motors, turbines, compressors, engines, robotics, vehicles, and appliances.

In the foreseeable future, the energy needed to support our economic growth will continue to come mainly from coal, our nation's most abundant and lowest cost resource. The performance of coal-fired power plants is highly dependent on coordinated and integrated sensing, control, and actuation technologies and products.

The implementation of sensors and advanced controls in power systems an provide valuable methods to improve operational efficiency, reduce emissions, and lower operating costs. As new power generation technologies and systems mature, the plant that encompasses these systems will become inherently complex. The traditional process control architecture that includes a conventional process layer, sensing layer, control layer, and actuation layer would no longer be sufficient. In order to manage complexity, the process control architecture that supports the plant control systems need to evolve to manage complexity and optimize performance.

On the other hand, with the advent of information technology, sensor networks have been implemented in more and more industrial plants. Most “modern” sensors and actuators are equipped with Fieldbus, a digital network for the industrial environment, that can send and receive useful information throughout the network. However, much of the information from the sensor networks is not very well utilized due to various reasons.

In the U.S. patent application No. 61/727,045, the entirety of which is hereby incorporated by reference, we described a Self-Organizing Process Control Architecture that comprises a Sensing Layer, Control Layer, Actuation Layer, Process Layer, as well as Self-Organizing Sensors (SOS) and Self-Organizing Actuators (SOA). A Self-Organizing Sensor with an artificial neural network (ANN) based dynamic modeling mechanism to measure a CFB Boiler Bed Height is presented. A method to develop a Self-Organizing Sensor that has one or multiple input variables is disclosed.

In the U.S. patent application, filed on Apr. 15, 2013 and entitled Self-Organizing Multi-Stream Flow Delivery Process and Enabling Actuation and Control, the entirety of which is hereby incorporated by reference, we described a self-organizing multi-stream flow delivery process and the enabling actuation and control system. The method and apparatus of building a general-purpose self-organizing multi-stream flow delivery process are presented. As a case example, an actuation and control system to control a multi-stream liquid flow delivery process using Self-Organizing Actuation and Control Units (SOACU) is described.

In the U.S. Pat. No. 6,684,112, the entirety of which is hereby incorporated by reference, we described a Robust Model-Free Adaptive (MFA) controller for effectively controlling simple to complex processes. The Robust MFA controller provides a wide robust range and can keep the process in control during normal and extreme operating conditions when there are significant disturbances or changes in process dynamics.

First introduced in 1997, the Model-Free Adaptive (MFA) control technology overcomes the shortcomings of traditional Proportional-Integral-Derivative (PID) controllers and is able to control various complex processes that may have one or more of the following behaviors: (1) nonlinear, (2) time-varying, (3) large time delay, (4) multi-input-multi-output, (5) frequent dynamic changes, (6) open-loop oscillating, (7) pH process, and (8) processes with large load changes and disturbances.

Since MFA is “Model-Free”, it also overcomes the shortcomings of model-based advanced control methods. MFA is an adaptive and robust control technology but it does not require (1) precise process models, (2) process identification, (3) controller design, and (4) complicated manual tuning of controller parameters. A series of U.S. patents and related international patents for Model-Free Adaptive (MFA) control and optimization technologies have been issued. Some of them are listed in Table 1.

TABLE 1

| U.S. Patent | Patent Name |
|---|---|
| 6,055,524 | Model-Free Adaptive Process Control |
| 6,556,980 | Model-Free Adaptive Control for Industrial Processes |
| 6,360,131 | Model-Free Adaptive Control for |
| | Flexible Production Systems |
| 6,684,115 | Model-Free Adaptive Control of Quality Variables (1) |
| 6,684,112 | Robust Model-Free Adaptive Control |
| 7,016,743 | Model-Free Adaptive Control of Quality Variables (2) |
| 7,142,626 | Apparatus and Method of Controlling |
| | Multi-Input-Single-Output Systems |
| 7,152,052 | Apparatus and Method of Controlling |
| | Single-Input-Multi-Output Systems |
| 7,415,446 | Model-Free Adaptive Optimization |

Commercial hardware and software products with Model-Free Adaptive control have been successfully installed in most industries and deployed on a large scale for process control, building control, and equipment control.

Although Model-Free Adaptive (MFA) controllers depart from the traditional control approaches and have solved many difficult control problems, they are mainly used as a component in the traditional process control architecture that comprises a Sensing Layer, Control Layer, Actuation Layer, and Process Layer. There are still many challenging problems in the field of automatic control where traditional process control architecture is no longer sufficient regardless of what controllers are used.

In this patent, we introduce a Self-Organizing Control Architecture that comprises a Sensing Layer, Control Layer, Actuation Layer, Process Layer, as well as Self-Organizing Sensors (SOS), Self-Organizing Actuators (SOA), and Self-Organizing Actuation and Control Units (SOACU). The method and apparatus of SOA and SOACU for process control are presented. A control system as a case example for a gas mixing process is described using the unique SOA and SOACU approaches. A 2x1 Robust MFA controller as a key component of the SOACU is also disclosed.

In the accompanying drawings:

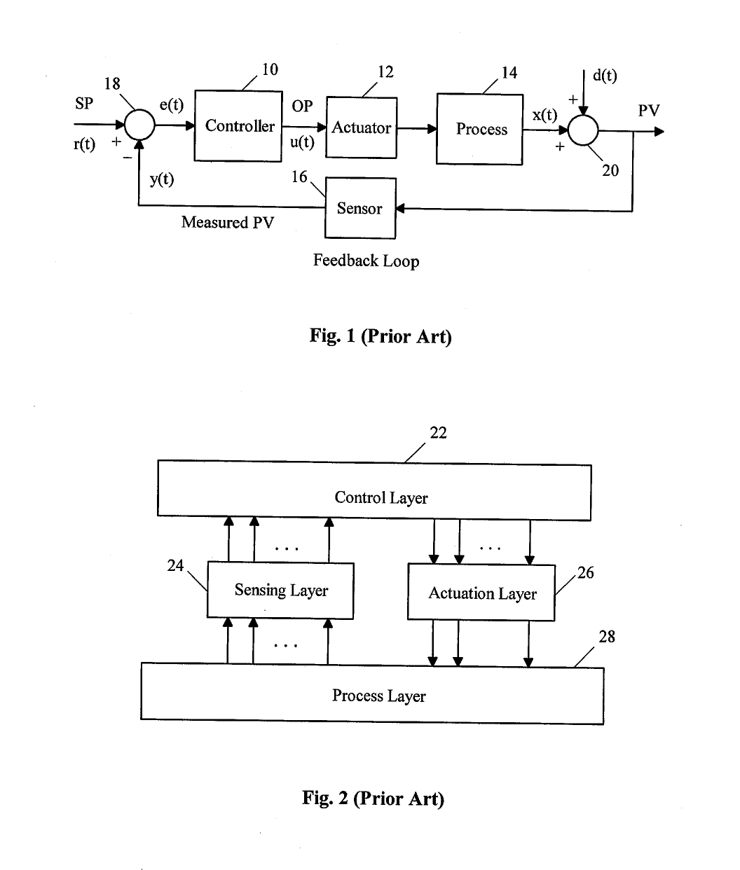

FIG. 1 is a block diagram illustrating a traditional single-loop automatic control system incorporating a sensor, controller, actuator, and process under control.

FIG. 2 is a block diagram illustrating a traditional process control architecture encompassing the Sensing Layer, Control Layer, Actuation Layer, and Process Layer.

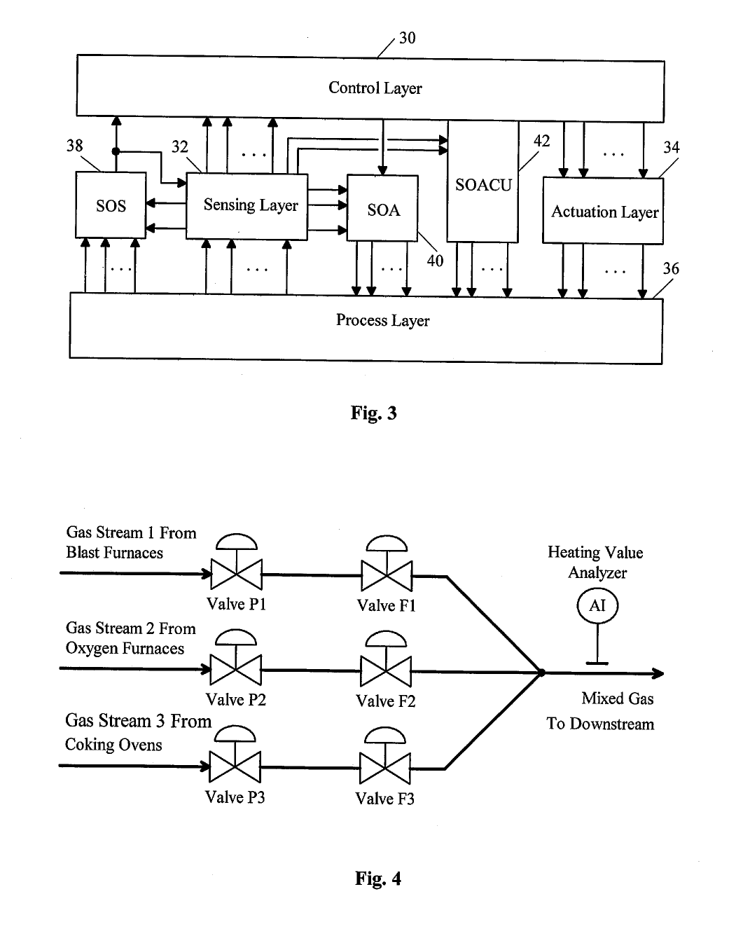

FIG. 3 is a block diagram illustrating a unique Self-Organizing Process Control Architecture comprising the Sensing Layer, Control Layer, Actuation Layer, Process Layer, as well as one or more of Self-Organizing Sensors (SOS), Self-Organizing Actuators (SOA), and/or Self-Organizing Actuation and Control Units (SOACU) according to an embodiment of this invention.

FIG. 4 is a process and instrument diagram illustrating a typical gas mixing process that comprises three gas streams.

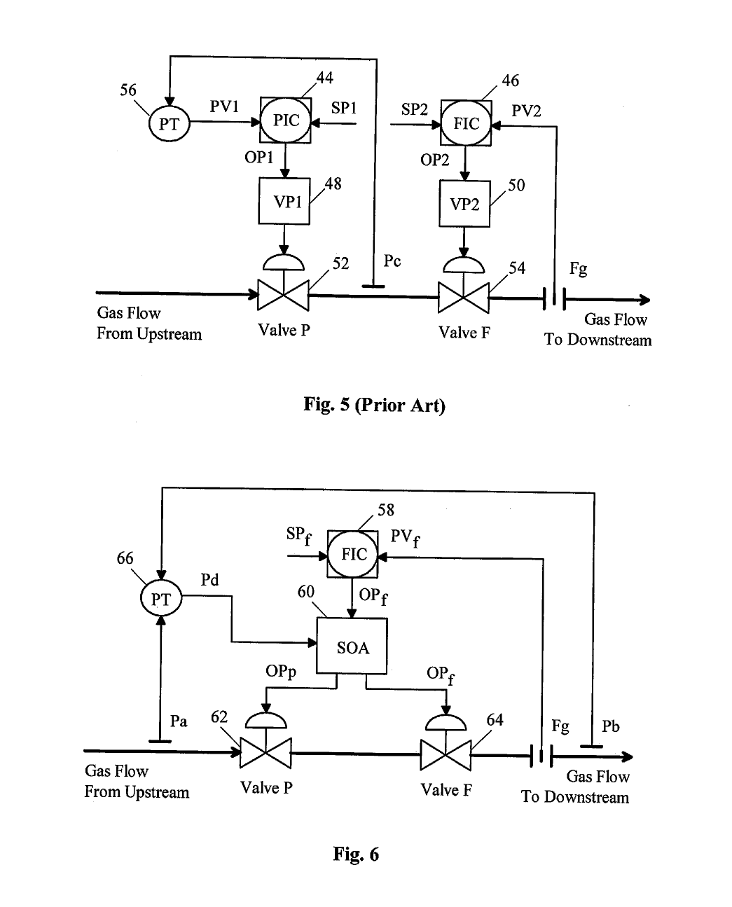

FIG. 5 is a process and instrument diagram illustrating a traditional dual loop gas flow control system comprising two controllers and two valve positioners to control a disruptive gas flow.

FIG. 6 is a process and instrument diagram illustrating a gas flow control system comprising a controller and a Self-Organizing Actuator (SOA) to control a disruptive gas flow according to an embodiment of this invention.

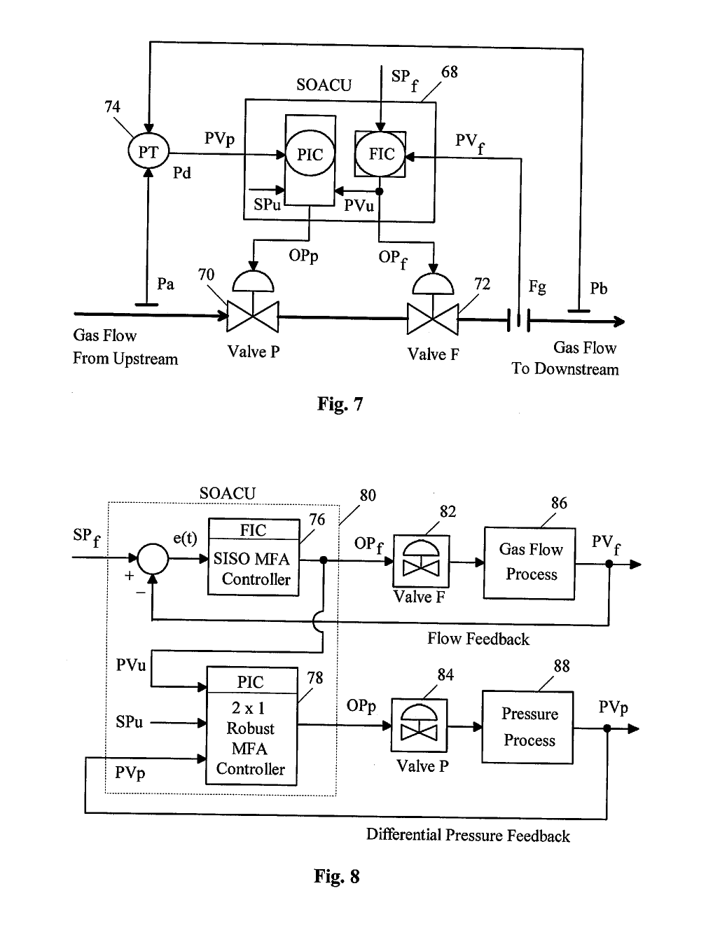

FIG. 7 is a process and instrument diagram illustrating a gas flow control system comprising a Self-Organizing Actuation and Control Unit (SOACU) to control a disruptive gas flow according to an embodiment of this invention.

FIG. 8 is a block diagram illustrating a gas flow control system comprising a SISO MFA controller and a 2x1 Robust MFA controller to show the composition of the Self-Organizing Actuation and Control Unit (SOACU) in FIG. 7 according to an embodiment of this invention.

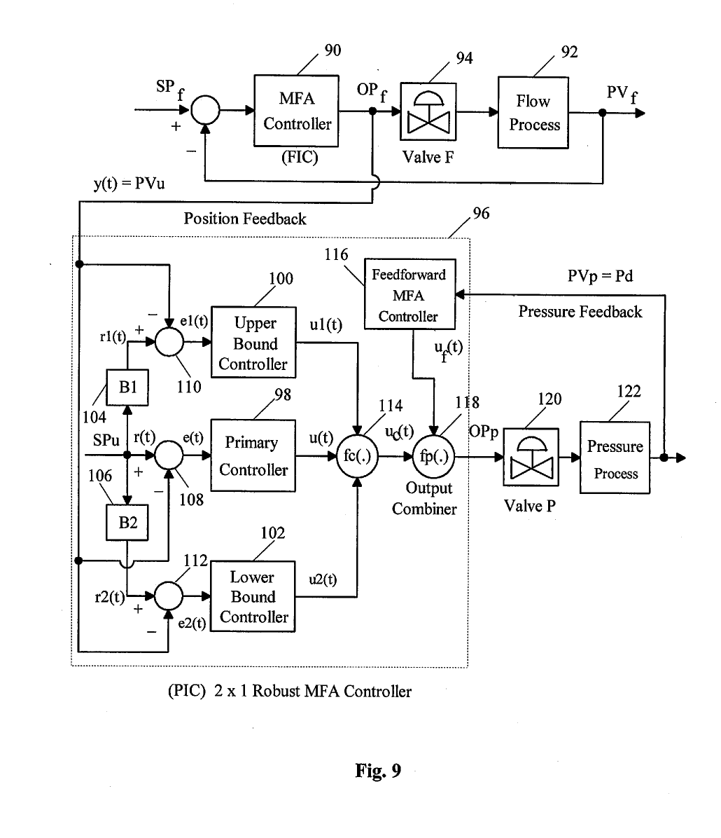

FIG. 9 is a block diagram illustrating the detailed design of a 2x1 Robust MFA controller as part of the Self-Organizing Actuation and Control Unit (SOACU) in FIGS. 7 and 8 according to an embodiment of this invention.

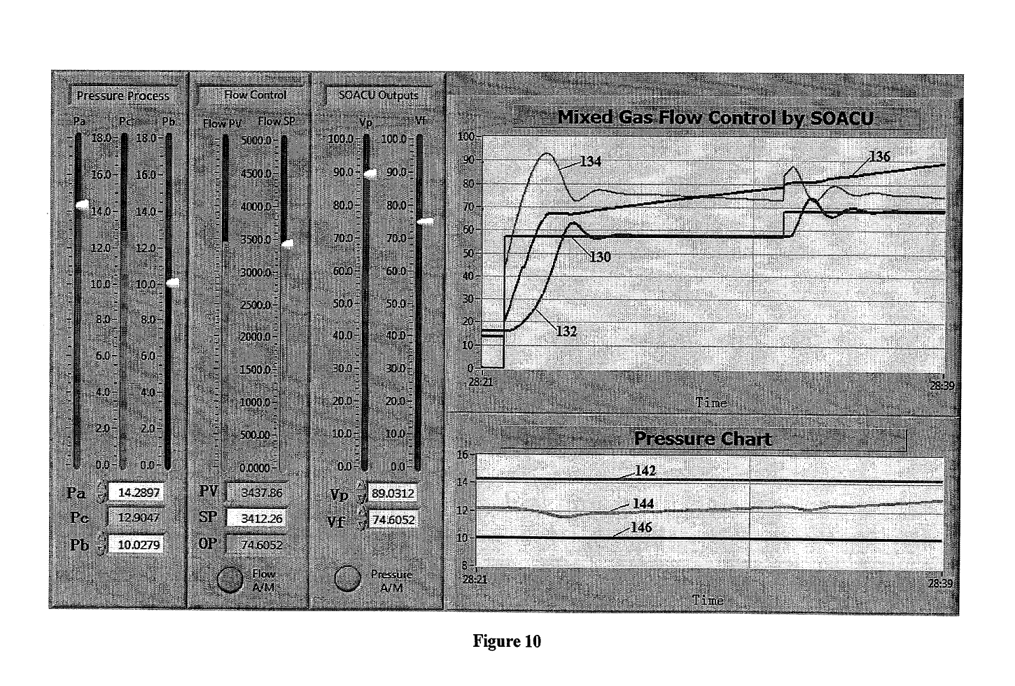

FIG. 10 is a time-amplitude diagram illustrating the real-time simulation trends of a gas flow control system comprising a Self-Organizing Actuation and Control Unit (SOACU) of FIGS. 7, 8, and 9 controlling a disruptive gas flow.

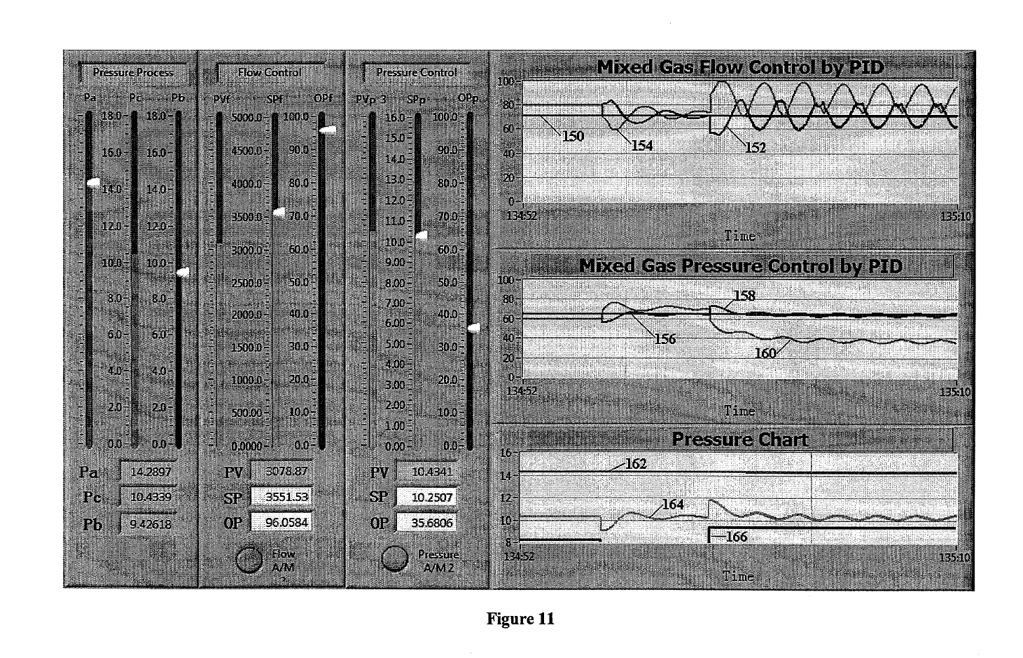

FIG. 11 is a time-amplitude diagram illustrating the real-time simulation trends of a traditional gas flow control system of FIG. 5 comprising two PID (Proportional-Integral-Derivative) controllers controlling a disruptive gas flow.

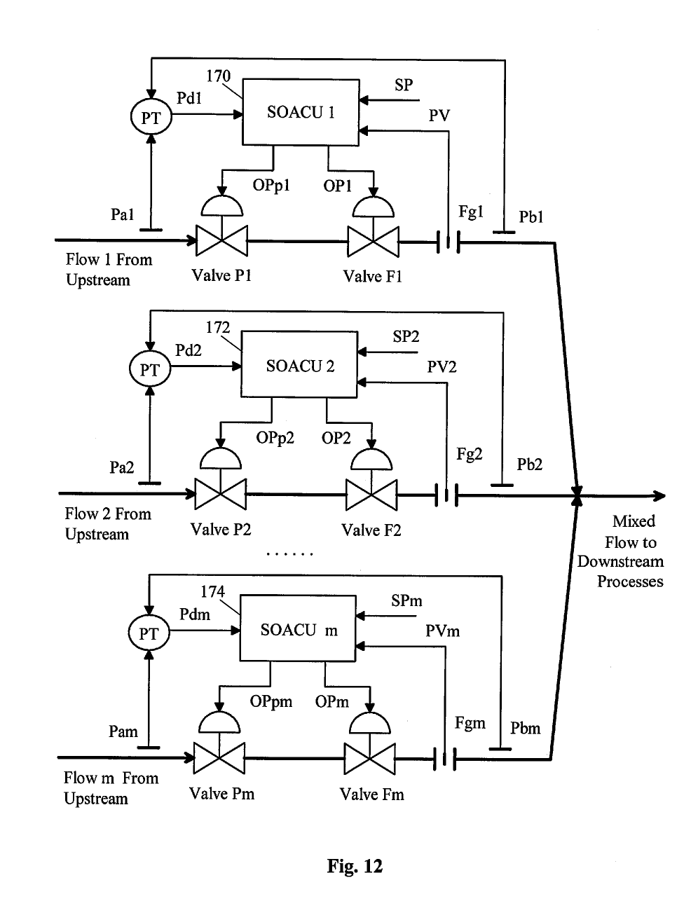

FIG. 12 is a process and instrument diagram illustrating a gas or liquid mixing process control system comprising multiple Self-Organizing Actuation and Control Units (SOACU) according to an embodiment of this invention.

In this patent, the term “mechanism” is used to represent hardware, software, or any combination thereof. The term “process” is used to represent a physical system or process with inputs and outputs that have dynamic relationships. The term “sensor” is used to represent a sensing mechanism. The term “actuator” is used to represent an actuation mechanism or an actuation device in a control system. The term “control loop” refers to a single-loop feedback control system. The term “SISO” refers to Single-Input-Single-Output. The term “2x1” refers to “2-Input-1-Output”. The term “MFA” refers to Model-Free Adaptive control or controllers.

Throughout this document, m=1, 2, 3, . . . , as an integer, which is used to indicate the number of gas or liquid flows in a multi-stream gas or liquid mixing process.

Throughout this document, if a method or apparatus is used to control a gas flow process, it may also be applied to a liquid flow process without departing from the spirit or scope of the invention. If a method or apparatus is used to control a liquid flow process, it may also be applied to a gas flow process without departing from the spirit or scope of the invention.

Throughout this document, if a method or apparatus is related to SOA, it may also be applied to SOACU; and if a method or apparatus is related to SOACU, it may also be applied to SOA without implication of equivalents or departing from the spirit or scope of the invention.

Without losing generality, all numerical values given in this patent are examples. Other values can be used without departing from the spirit or scope of the invention. The description of specific embodiments herein is for demonstration purposes and in no way limits the scope of this disclosure to exclude other non-specifically described embodiments of this invention.

### Description

### A. Traditional Process Control Architecture

Traditionally, automatic control is based on the concept of feedback. The essence of the feedback theory consists of three components: measurement, comparison, and correction. Measuring the quantity of the variable to be controlled, comparing it with the desired value, and using the error to correct the control action is the basic procedure of feedback automatic control.

FIG. 1 is a block diagram illustrating a traditional single-loop automatic control system incorporating a Controller 10, an Actuator 12, Process 14, a Sensor 16, and Adders 18 and 20. The Sensor 16 measures the Process Variable (PV) to be controlled. The Measured Process Variable y(t) is compared at Adder 18 with the Setpoint (SP) signal r(t) to produce an error signal e(t), which is used as the input to the Controller 10. The control objective is for the Controller 10 to produce an output (OP) signal u(t) to drive the Actuator 12 to manipulate the Process 14 so that the Process Variable (PV) tracks the given trajectory of the Setpoint. The signals shown in FIG. 1 are as follows:

r(t)—Setpoint (SP),

PV—Process Variable, PV=x(t)+d(t),

y(t)—Measured Process Variable,

x(t)—Process Output,

u(t)—Controller Output (OP),

d(t)—Disturbance, the disturbance caused by noise or load changes,

e(t)—Error between the Setpoint and Measured Variable, e(t)=r(t)−y(t).

For simplification, the sensor and actuator are typically included as part of the process. Therefore, the Measured Process Variable y(t) can be considered the same as the Process Variable.

FIG. 2 is a block diagram illustrating a traditional process control architecture encompassing the Control Layer 22, Sensing Layer 24, Actuation Layer 26, and Process Layer 28. Noting that both FIGS. 1 and 2 show the signals flow from the Process to Sensing, to Control, to Actuation, and then to Process in a loop. That is why a feedback control system is sometimes referred to as a control loop.

The Process Layer includes physical processes or systems with inputs and outputs that have dynamic relationships. For instance, a gas mixing process in an iron and steel plant is a physical process that has multiple process variables to be controlled.

The Sensing Layer includes multiple sensors for measuring various process variables. These sensors can vary significantly in size, type, and physical characteristics. For a gas mixing process, gas flows, gas pressures, and the heating value of mixed gas are measured by their respective sensors.

The Control Layer includes multiple automatic controllers for controlling various process variables. The controllers are typically implemented in control devices such as Distributed Control Systems (DCS), Programmable Logic Controllers (PLC), Programmable Automation Controllers (PAC), Single-Loop Controllers (SLC), or computer software. The controllers include Inputs/Outputs (I/Os), communication buses, or digital networks to interface with sensors and actuators. The Setpoints are the target values for the process variables to track, which are entered, managed, and monitored in the Control Layer. The Control Layer usually includes a Graphical User Interface (GUI) for the operators to monitor the process and control system.

The Actuation Layer includes multiple actuators that take control command signals from the controllers and manipulate certain process inputs or manipulated variables to achieve the control objectives. In a gas mixing process control system, multiple control valves and valve positioners are used as actuators.

A valve positioner is an analog or digital device that controls the valve stem position. It is used to assure that the valve moves to the position that the controller demands. A valve positioner could help deal with variations and issues in packing friction due to dirt, corrosion, lack of lubrication, wear and tear, valve stiction, dead band, and valve nonlinear behavior. It is commonly seen in industrial flow control applications where there are one or more of the following situations: (i) high pressure across the valve, (ii) high pressure applications with tight packing, (iii) valves with wide throttling range, and (iv) valves handling sludge or solids in suspension.

To summarize, a traditional process control architecture may possess the following properties:

1. Multiple sensors for measuring various process variables may exist. However, they send the measurement signals to the Control Layer only;

2. Multiple actuators for controlling different process variables may exist. However, they take commands from the Control Layer only; and

3. A sensor network may exist, but sensors do not talk to each other.

### B. Self-Organizing Process Control Architecture

In regard now to the present invention, we will first review the concept of Distributed Intelligence, Self-Organizing, and other related terms in preparation for further discussions of the invention.

### Distributed Intelligence

Distributed Intelligence can be considered an artificial intelligence method that includes distributed solutions for solving complex problems. It is closely related to Multi-Agent Systems.

### Self-Organizing

Without using strict and academic type definitions, Self-Organizing can be understood as an organization that is achieved in a way that is parallel and distributed. Here, parallel means that all the elements act at the same time, and distributed means no element is a central coordinator.

### Self-Organizing System

A self-organizing system is a complex system made up of small and simple units connected to each other and having self-organizing capabilities.

FIG. 3 is a block diagram illustrating a unique Self-Organizing Process Control Architecture comprising a Sensing Layer, Control Layer, Actuation Layer, Process Layer, as well as one or more of Self-Organizing Sensors (SOS), Self-Organizing Actuators (SOA), and/or Self-Organizing Actuation and Control Units (SOACU) according to an embodiment of this invention.

More specifically, the Self-Organizing Process Control Architecture not only comprises the Control Layer 32, Sensing Layer 34, Actuation Layer 36, Process Layer 38, but also one or more of Self-Organizing Sensors (SOS) 40, Self-Organizing Actuators (SOA) 42, and/or Self-Organizing Actuation and Control Units (SOACU) 44.

Notice that the signal flows are not as simple as those of traditional feedback control loops. The Self-Organizing Sensors (SOS), Self-Organizing Actuators (SOA), and Self-Organizing Actuation and Control Units (SOACU) can have direct inputs from the sensor networks. The intelligence has not only been distributed in the sensing, actuation, and control layers, but has also been utilized. The signal flows indicate that this architecture is beyond the scope of traditional control schemes.

This Self-Organizing Process Control Architecture can have one or more of the following properties:

1. Sensors may send measurement signals to other sensors and actuators;

2. A Self-Organizing Actuator (SOA) takes commands from the Controller and may have inputs from sensors;

3. Sensors may talk to each other;

4. A Self-Organizing Sensor (SOS) can have multiple inputs from the sensor networks;

5. A Self-Organizing Sensor (SOS) can send its output to the sensor networks;

6. A Self-Organizing Actuator (SOA) can manipulate multiple manipulated variables in a coordinated way at the same time;

7. A Self-Organizing Actuation and Control Unit (SOACU) incorporates controllers and valve or damper positioners, and provides multiple output signals to manipulate multiple valves, dampers, or other actuation devices in a coordinated way at the same time; and

8. A Multivariable Self-Organizing Actuation and Control Unit (SOACU) can control multiple process variables.

Potential key differences, one or more of which may exist between the traditional process control architecture and the Self-Organizing Process Control Architecture, are compared and summarized in Table 2.

TABLE 2

| | | Traditional Process | Self-Organizing Process |
|---|---|---|---|
| No. | Common Property | Control Architecture | Control Architecture |
| 1 | Multiple sensors for | Sensors send the | Sensors may also send |
| | measuring various | measurement signals to | measurement signals to other |
| | process variables may | the Control Layer only. | sensors and actuators. |
| | exist. | | |
| 2 | Multiple actuators for | Actuators take | A Self-Organizing Actuator |
| | controlling different | commands from the | (SOA) takes commands from |
| | process variables may | Control Layer only. | the Controller and may have |
| | exist. | | inputs from sensors. |
| 3 | A sensor network | Sensors do not talk to | Sensors may talk to each other. |
| | may exist. | each other. | |
| 4 | A sensor typically | A sensor typically has | A Self-Organizing Sensor |
| | measures one physical | only one or two inputs. | (SOS) can have multiple inputs |
| | property. | | from the sensor networks. |
| 5 | N/A | N/A | A Self-Organizing Sensor |
| | | | (SOS) can send its output to |
| | | | the sensor networks. |
| 6 | N/A | An actuator typically | A Self-Organizing Actuator |
| | | manipulates one | (SOA) can manipulate multiple |
| | | manipulated variable. | variables in a coordinated way. |
| 7 | N/A | N/A | An SOACU incorporates |
| | | | controllers and valve or damper |
| | | | positioners, and provides |
| | | | multiple output signals to |
| | | | manipulate multiple valves, |
| | | | dampers, or other actuation |
| | | | devices in a coordinated way. |
| 8 | N/A | N/A | A Multivariable Self- |
| | | | Organizing Actuation and |
| | | | Control Unit (SOACU) can |
| | | | control multiple process |
| | | | variables. |

### C. Self-Organizing Actuation (SOA) For Gas Mixing Process Control

To realize and describe the concept, properties, and significance of the Self-Organizing Process Control Architecture, a realistic actuation scenario is investigated in the context of an industrial process control application where conventional actuators do not work well.

In an iron and steel complex, operating units including blast furnaces, basic oxygen furnaces, and coking ovens all produce gases as byproducts. A gas plant mixes these gases to produce fuel for the furnaces in metal casting and rolling mills. The quality of the mixed gas is measured by its Heating Value. Gases with inconsistent Heating Value can cause safety, product quality, and production problems due to over or under heating.

Even during normal production, gas supply and demand can change randomly and significantly. Major operating units such as blast furnaces in the upstream and reheating furnaces in the downstream may go online and offline periodically causing huge disturbances in gas flows and gas pressures. In order to control the gas mixing process, two control valves are used for each of the gas streams as shown in a 3-stream mixed gas process in FIG. 4.

FIG. 4 is a process and instrument diagram illustrating a typical gas mixing process that comprises three gas streams. In order to effectively control the gas flow, each gas stream pipeline is equipped with a pressure control valve and a flow control valve. Valve P1 and Valve F1 are used to control the gas flow from blast furnaces, Valve P2 and Valve F2 are used to control the gas flow from oxygen furnaces, and Valve P3 and Valve F3 are used to control the gas flow from coking furnaces. Gases from these three streams are mixed and sent to the downstream processes. The heating value of the mixed gas is measured online by a heating value analyzer (AI). When the steel plant is running, large disturbances in the gas grid, frequent changes in gas supply and demand, nonlinearity of the control valves, and varying process dynamics can cause a conventional control system to have various problems resulting in inconsistent heating value in the mixed gas. The product quality and production efficiency suffer in the downstream processes.

To simplify, we focus on just one gas stream to describe the challenges and methods for controlling a disruptive gas flow process. A disruptive gas flow process is defined to have one or more of the following behaviors: (i) the upstream flow supply and pressure can change significantly; (ii) the downstream flow demand and pressure can change significantly; and/or (iii) the pressure differential between the upstream and downstream gas pipelines is so large that two control valves for each gas flow are required, one for pressure and one for flow.

FIG. 5 is a process and instrument diagram illustrating a traditional dual loop gas flow control system comprising two controllers and two valve positioners to control a disruptive gas flow. The system comprises a pressure controller (PIC) 44, a flow controller (FIC) 46, valve positioners 48 and 50, a pressure valve 52, a flow valve 54, and a pressure transducer (PT) 56. A pressure controller (PIC) 44 manipulates the pressure valve 52 through the valve positioner 48 to control pressure Pc, which is the pressure between the 2 valves. The flow controller (FIC) 46 manipulates the flow valve 54 through the valve positioner 50 to control the gas flow Fg.

The objective is to control the gas flow. The pressure controller is required to keep the differential pressure Pd stable so that the gas flow Fg can be effectively controlled. Although this design seems reasonable, it has fundamental flaws. Mainly, these 2 valves are side-by-side trying to control the same gas flow. When the PIC tries to regulate the gas pressure, it affects the gas flow. When the FIC tries to control the gas flow, it affects the gas pressure. So, these two control loops will have a see-saw battle resulting in loop oscillations, inconsistent gas mixing, and large heating value variations. This is a classical industrial process control application, where conventional actuators do not work well.

FIG. 6 is a process and instrument diagram illustrating a gas flow control system comprising a controller and a Self-Organizing Actuator (SOA) to control a disruptive gas flow according to an embodiment of this invention. The system comprises a flow controller (FIC) 58, a Self-Organizing Actuator (SOA) 60, a pressure valve 62, a flow valve 64, and a pressure transducer (PT) 66.

Since the objective is to control the gas flow, there is no need to have a pressure controller. The system is designed to include a single-loop Flow Controller FIC, and a Self-Organizing Actuator (SOA) that can manipulate the pressure valve and flow valve in a coordinated way at the same time.

The components comprised in the gas flow control system using the traditional approach in FIG. 5 and the unique SOA approach in FIG. 6 are listed in Table 3.

TABLE 3

| Symbol | Traditional Approach | SOA Approach |
|---|---|---|
| FIC | Flow Controller | Flow Controller |
| PIC | Pressure Controller | N/A |
| PT | Pressure Transducer | Pressure Transducer |
| VP1, VP2 | Valve positioners | N/A |
| SOA | N/A | Self-Organizing Actuator |
| Fg | Gas Flow | Gas Flow |
| Pa | Head Pressure | Head Pressure |
| Pb | Back Pressure | Back Pressure |
| pc | Middle Pressure | N/A |
| Pd | N/A | Differential Pressure = Pa − Pb |

Please note that Pc is the Middle Pressure between the two valves. If an automatic controller is used to control the pressure, only the Middle Pressure can be controlled. The Head Pressure Pa and Back Pressure Pb are dictated by the upstream and downstream processes so that they cannot be controlled. Using the SOA approach, we will not try to control the pressure. The objective is to adjust the pressure to affect the flow valve operating condition. Therefore, the Differential Pressure Pd=Pa−Pb is used as the feedforward signal.

The Self-Organizing Actuator (SOA) can be designed based on the following method:

1. Design the control algorithm and logic so that the pressure control valve can achieve the following objectives: (a) stabilize the differential pressure; (b) regulate the pressure so that the flow control valve works within its relatively linear range such as 25% to 75%, and (c) eliminate or reduce any unnecessary movement of the pressure valve to avoid see-saw battles between the two valves;

2. Incorporate the valve positioning functions into SOA so that external valve positioners are not required;

3. The output (OP) signal of the flow controller may pass through the SOA or may be enhanced by an internal valve positioner to produce output OP_{f} to manipulate the flow valve;

4. The output (OP_{f}) signal of the flow controller is used as a “valve position feedback” signal along with the differential pressure signal Pd for the SOA to produce output OPp to manipulate the pressure valve; and

5. The Robust MFA control technology described in the U.S. Pat. No. 6,684,112 can be incorporated into the design of the Self-Organizing Actuator (SOA).

### D. Self-Organizing Actuation and Control Unit (SOACU)

When incorporating the flow controller FIC with the SOA in FIG. 6, we developed a unique Self-Organizing Actuation and Control Unit (SOACU) that can be even more powerful and user-friendly than SOA.

FIG. 7 is a process and instrument diagram illustrating a gas flow control system comprising a Self-Organizing Actuation and Control Unit (SOACU) to control a disruptive gas flow according to an embodiment of this invention. The system comprises a Self-Organizing Actuation and Control Unit (SOACU) 68, a pressure valve 70, a flow valve 72, and a pressure transducer (PT) 74.

The SOACU 68 comprises an internal flow controller FIC and an internal pressure controller PIC. Designed to work as one unit, the SOACU has two inputs PVp and PV_{f}, two outputs OPp and OP_{f}, a user selectable Setpoint SP_{f}, an internal Setpoint SPu, and an internal feedback PVu. The components and key variables comprised in the gas flow control system using the SOA approach in FIG. 6 and the SOACU approach in FIG. 7 are listed in Table 4.

TABLE 4

| Symbol | SOA | SOACU |
|---|---|---|
| FIC | External Flow Controller | Internal Flow Controller |
| PIC | Internal Pressure Controller | Internal Pressure Controller |
| SP_{f} | Flow Control Setpoint | Flow Control Setpoint |
| SPu | Internal PIC Setpoint | Internal PIC Setpoint |
| PV_{f} | Flow Process Variable | Flow Process Variable |
| PVp | Pressure Process Variable | Pressure Process Variable |
| OP_{f} = PVu | Output to Flow Valve = | Output to Flow Valve = |
| | Position Feedback | Position Feedback |
| OPp | Output to Pressure Valve | Output to Pressure Valve |
| Fg | Gas Flow | Gas Flow |
| Pa | Head Pressure | Head Pressure |
| Pb | Back Pressure | Back Pressure |
| Pd | Differential Pressure | Differential Pressure |

Inside the SOACU 68, there is a pressure controller PIC and a flow controller FIC. The PIC has two inputs PVp and PVu, and one output OPp. So, it is a 2-Input-1-Output (2x1) controller. Its setpoint SPu can be set using a pre-determined default value such as 50%, which is the mid point of the “linear” range (25%-75%) of the flow valve. This way, the user does not need to enter a setpoint for the internal PIC controller. The flow controller FIC has one input PV_{f} and one output OP_{f}. Its setpoint SP_{f} is the user selectable target value for the flow.

FIG. 8 is a block diagram illustrating a gas flow control system comprising a SISO MFA controller and a 2x1 Robust MFA controller to show the composition of the Self-Organizing Actuation and Control Unit (SOACU) in FIG. 7 according to an embodiment of this invention. The system comprises a Self-Organizing Actuation and Control Unit (SOACU) 80, a flow valve 82, a gas flow process 86, a pressure valve 84, and a pressure process 88. The SOACU 80 further comprises a SISO MFA controller 76, and a 2x1 Robust MFA controller 78.

The control objective is for the Self-Organizing Actuation and Control Unit (SOACU) to produce two outputs OP_{f} and OPp to manipulate the flow valve and pressure valve in a coordinated way so that the gas flow tracks its setpoint SP_{f} under all operating conditions. The SISO MFA controllers that can be used in this embodiment have been described in U.S. Pat. Nos. 6,055,524 and 6,556,980. The 2x1 Robust MFA controller is a unique controller that will be described in FIG. 9.

FIG. 9 is a block diagram illustrating the detailed design of a 2x1 Robust MFA controller as part of the Self-Organizing Actuation and Control Unit (SOACU) in FIGS. 7 and 8 according to an embodiment of this invention. In FIG. 9, the 2x1 Robust MFA Controller 96 comprises a Primary Controller 98, an Upper-bound Controller 100, a Lower-bound Controller 102, an Upper-bound Setpoint Setter 104, a Lower-bound Setpoint Setter 106, Signal Adders 108, 110, 112, a Constraint Setter 114, a Feedforward MFA Controller 116, and an Output Combiner 118. The 2x1 MFA controller generates an output control signal OPp to manipulate the Pressure Valve 120 to control the Pressure Process 122. Since the Upper-bound Controller 100 and Lower-bound Controller 102 provide constraints to the output of the Primary Controller, they are also called Constraint Controllers.

In FIG. 9, there is also a flow control sub-system, where an MFA Controller 90 manipulates the flow valve 94 to control the flow process 92. The output signal OP_{f} of the flow controller is used as the position feedback signal for the 2x1 Robust MFA Controller. This is the primary feedback signal PVu for the 2x1 Robust MFA controller.

The signals shown in FIG. 9 are as follows:

r(t)=SPu—Setpoint of the 2x1 Robust MFA controller,

y(t)=PVu—Process Variable 1 for the 2x1 Robust MFA controller,

u(t)—Primary Controller Output,

e(t)—Error between the Setpoint and Process Variable, e(t)=SPu−PVu,

r₁(t)—Upper-bound Controller Setpoint,

r₂(t)—Lower-bound Controller Setpoint,

u₁(t)—Upper-bound Controller Output,

u₂(t)—Lower-bound Controller Output,

uₑ(t)—The Combined Controller Output,

e₁(t)—Error between r₁(t) and y(t), e₁(t)=r₁(t)−y(t),

e₂(t)—Error between r₂(t) and y(t), e₂(t)=r₂(t)−y(t),

Pd=PVp—Differential Pressure=Process Variable 2 for the 2x1 Robust MFA controller,

u_{f}(t)—Feedforward MFA Controller Output, and

OPp—2x1 Robust MFA Controller Output.

As shown in FIG. 9, controllers 100 and 102 are used as the Upper-bound and Lower-bound constraint controllers, respectively. They can provide smart upper and lower boundaries for Process Variable y(t). The Constraint Setter 114 forces u(t) to be bounded by the controller outputs u₁(t) and u₂(t) under certain conditions.

To setup a Robust MFA control system, the user is allowed to enter an Upper-bound (UB) and a Lower-bound (LB) for the Process Variable (PV). These bounds are typically the marginal values that the Process Variable should not go beyond.

It is important to understand that a process variable (PV) is unlike a controller output (OP). A hard limit or constraint can be set for OP since it is a signal produced by a controller. PV is the measured variable for the process output. Its value is a signal obtained from a measurement device such as a sensor. Therefore, trying to limit the PV within a bound can only be done by changing the controller OP to manipulate the process input, which will affect the process output, the PV. To summarize, the PV Upper and Lower bounds are very different than the OP constraints.

The PV Upper and Lower bounds for a Robust MFA controller can be set based on several options as described in the U.S. Pat. No. 6,684,112. In this 2x1 Robust MFA controller case, we can set the bounds relating to the setpoint as follows:

The Upper-bound is based on the primary controller setpoint as follows:

r₁(t)=r(t)+B₁, (1)

where B₁>0 is a Relative Bound to the setpoint r(t).

The Lower-bound is based on the primary controller setpoint as follows:

r₂(t)=r(t)−B₂, (2)

where B₂>0 is a Relative Bound to the setpoint r(t).

For instance, if we let B₁=B₂=25%, a +/−25% upper and lower bound is set around the setpoint r(t). The bounds move as the setpoint changes. For instance, if Setpoint r(t)=50%, Upper-bound=75%, and Lower-bound=25%.

The Constraint Setter 114 is a limit function f_{c}(•) that combines the controller output signals based on the following logic:

u_{c}(t)=u₁(t), if u(t)>u₁(t) (3)

u_{c}(t)=u(t), if u₂(t)≦u(t)≦u₁(t) (4)

u_{c}(t)=u₂(t), f u(t)<u₂(t) (5)

where u₁(t) is the output of Upper-bound Controller 100, u₂(t) is the output of Lower-bound Controller 102, u(t) is the output of Primary Controller 98, and u_{c}(t) is the output of the limit function f_{c}(•).

SISO MFA controllers can be used for the Primary Controller 98 and the Constraint Controllers 100 and 102. The SISO MFA controllers that can be used in this embodiment have been described in U.S. Pat. Nos. 6,055,524 and 6,556,980. The MFA controller parameters have been described in these patents, which include:

K_{c}—MFA controller Gain, and

T_{c}—MFA controller Time Constant.

If the Primary Controller 88 is set with K_{c} and T_{c}, the Constraint Controllers 90 and 92 can be set based on, but not limited to, the following formula:

K_{c1}=α₁K_{c} (6)

T_{c1}=β₁T_{c} (7)

K_{c2}=α₂K_{c} (8)

T_{c2}=β₂T_{c} (9)

where K_{c1}, K_{c2}, T_{c1}, and T_{c2}, are the MFA Controller Gain and Time Constant for the Upper-bound Controller and Lower-bound Controllers, respectively; and α₁, α₂, β₁, and β₂ are positive coefficients that can be set with pre-determined default values or re-configured by the user. For instance, we can let α₁=α₂=3, and β₁=β₂=0.7. That means, the Constraint Controllers will have a larger gain and a smaller time constant so that they will react faster compared to the Primary Controller. The objectives of the Constraint Controllers are to limit the PV from going out of pre-determined upper and lower bounds.

As shown in FIG. 9, the 2x1 Robust MFA Controller 96 comprises another important component, the Feedforward MFA Controller 116. Feedforward control, as the name suggests, is a control scheme to take advantage of forward signals. If a process has a significant potential disturbance and the disturbance can be measured, we can use a feedforward controller to reduce the effect of the disturbance to the control system before the feedback control action takes place. In this case, the differential pressure Pd, which is the Process Variable PVp of the pressure process is used as the feedforward signal for the Feedforward MFA controller 116. Since the random gas supply and demand changes in the upstream and downstream processes are quickly reflected in the differential pressure Pd, it is a “perfect” feedforward signal.

The Feedforward MFA controllers that can be used in this embodiment have been described in U.S. Pat. Nos. 6,556,980, 6,684,115, and 7,016,743.

The Output Combiner 118 is a function fₚ(•) that combines the control output signal u_{c}(t) with the Feedforward MFA controller output signal u_{f}(t). It can be designed in different ways. For instance, the output signals can be combined based on the following formula:

OPp=u_{c}(t)+Δu_{f}(t), (10)

where u_{c}(t) is in the range of [0, 100], Δu_{f}(t) is the delta value of u_{f}(t), which is in the range of [−50, 50], and OPp is in the range of [0, 100].

To summarize, the 2x1 Robust MFA controller will provide one or more of the following functions:

1. If there is a big change in differential pressure, the 2x1 controller will take immediate action to regulate the pressure valve to compensate for the change;

2. If the flow valve position is within the pre-determined Upper-bound and Lower-bound, the 2x1 controller will maintain the current differential pressure so that the flow control sub-system can function adequately;

3. If the flow valve position is near or beyond the Upper-bound or Lower-bound, the 2x1 controller will adjust the pressure valve to affect the differential pressure as well as the flow condition so that the flow valve position is gradually moving back within the bound; and

4. If a big disturbance occurs causing the flow valve position to go outside the Upper-bound or Lower-bound quickly, the 2x1 controller will make an immediate control action by adjusting the pressure valve to slow down this momentum. This action will help the flow controller regulate the flow under this abnormal operating condition. In this case, two valves move towards the same direction in a coordinated way at the same time.

FIG. 10 is a time-amplitude diagram illustrating the real-time simulation trends of a gas flow control system comprising a Self-Organizing Actuation and Control Unit (SOACU) of FIGS. 7, 8, and 9 controlling a disruptive gas flow.

In FIG. 10, there are three control and monitoring faceplates on the left and there are two trend charts on the right. The Pressure Process faceplate shows pressure Pa, Pc, and Pb in Kilopascal (kPa), where Pa is the head pressure, Pc is the middle pressure, and Pb is the back pressure. The Flow Control faceplate shows the flow PV and SP in Cubic Meters per Hour (m³/h). The “SOACU Outputs” faceplate shows the two output signals Vp and V_{f} that regulate the pressure valve and flow valve, respectively.

The trend chart on the top shows Flow SP 130, Flow PV 132, V_{f} 134, and Vp 136. It can be seen that the SOACU provides good control for the flow where there are large setpoint changes. Please note that after the first setpoint change, Vp 136 goes up quickly in the same direction as V_{f} 134. During this time, both valves need to open to let the flow increase. Then, while V_{f} 134 is reduced to keep the flow PV tracking its SP, Vp 136 continues to rise. This action is actually trying to bring V_{f} down gradually because V_{f} is higher than the Upper-bound set at 75%. During the second setpoint change, Vp 136 did not go up as quickly as V_{f}. This is because the pressure valve is already open widely enough to allow the flow to pass through. The self-organizing actions between the two valves are evident by studying the trends.

The trend chart at the bottom shows Pa 142, Pc 144, and Pb 146. The head pressure Pa dictated by the upstream process and back pressure Pb dictated by the downstream process did not change. The middle pressure Pc changed following the pressure valve and flow valve changes as expected.

FIG. 11 is a time-amplitude diagram illustrating the real-time simulation trends of a traditional gas flow control system of FIG. 5 comprising two PID (Proportional-Integral-Derivative) controllers controlling a disruptive gas flow.

In FIG. 11, there are three control and monitoring faceplates on the left and there are three trend charts on the right. The Pressure Process faceplate shows pressure Pa, Pc, and Pb in Kilopascal (kPa), where Pa is the head pressure, Pc is the middle pressure, and Pb is the back pressure. The Flow Control faceplate shows the flow PV, flow SP in Cubic Meters per Hour (m³/h), and flow OP in 0%-100%. The Pressure Control faceplate shows the pressure PV, pressure SP in Cubic Meters per Hour (m³/h), and pressure OP in 0%-100%.

The trend chart on the top shows the PID control loop for the disruptive gas flow with signals of Flow SP 150, PV 152, OP 154. The trend chart in the middle shows the PID control loop for the disruptive gas pressure with signals of Flow SP 156, PV 158, OP 160. As illustrated in the process and instrument diagram of FIG. 5, the pressure under control is Pc, which is the pressure between the two valves.

The trend chart at the bottom shows Pa 162, Pc 164, and Pb 166. The head pressure Pa dictated by the upstream process and back pressure Pb dictated by the downstream process did not change. The middle pressure Pc changes following the pressure valve and flow valve changes.

In FIG. 11, the back pressure Pb 166 had two sudden changes causing disturbances to the flow. It can be seen that the two PID controller loops started to oscillate and interfere with each other. Also, the performance of the PID controllers is sensitive to operating conditions. For instance, we may see that one valve moves one direction until it hits its upper or lower limit and stays there. This is because when two single-loop controllers start to fight, the stronger controller will dictate. Typically, the FIC is set to be more aggressive. When the PIC is trying to control the pressure in order to reach its setpoint, it may have to keep going until it hits its upper or lower limit. In other words, the disruptive gas flow process is actually a multivariable process. The operating conditions of the pressure and flow are related. When using two single-loop controllers, the control system may get into an un-controllable condition.

Based on our comprehensive lab simulations and experience in real projects, the control performance of single-loop PID controllers versus Self-Organizing Actuation and Control Unit (SOACU) for controlling a gas-mixing process is analyzed and summarized in Table 5.

TABLE 5

| Item | Traditional Approach | SOACU Approach |
|---|---|---|
| Loop interactions | The flow and pressure | The flow and pressure loops |
| | loops may fight with each | coordinate with each other. |
| | other. | |
| Control system stability | Not reliable. | Reliable. |
| Sudden pressure changes on | Disturbance to flow is | Disturbance to flow is smaller. |
| Pa and Pb | larger. | |
| Controller parameter tuning | Sensitive to parameter | Not sensitive to parameter |
| | tuning. | tuning. |
| Working range | Poor performance | Can move away from the |
| | working in nonlinear | nonlinear range. |
| | range. | |
| Control performance in | Flow and pressure | Performance is consistent. |
| varying operating conditions | oscillations or PIC cannot | |
| | maintain control. | |
| Coordination between | Not capable. | Control outputs OP_{f} and OPp |
| pressure and flow control | | act in a coordinated way. |

Generally speaking, compared with the traditional control approach, the SOA and SOACU approaches demonstrate the following capabilities.

1. Stability of the control system is significantly improved because it avoids the potential conflict of control actions by two control valves;

2. When the upstream or downstream pressure changes, the SOACU shows much smaller disturbance to the flow. This is due to the fact that SOACU has a feedforward MFA controller that takes the differential pressure as a feedforward signal so that it can quickly manipulate the pressure valve to compensate for the pressure disturbances;

3. The PID controllers are sensitive to tuning parameters. It is seen that the flow and pressure loops may show oscillations when working in nonlinear range;

4. The PID based pressure and flow control loops may fight each other resulting in undesirable control performance. The SOACU can manipulate the pressure valve and flow valve in a coordinated way. It can be seen that when there is a setpoint change, the flow control output OP_{f} changes quickly to perform flow control. On the other hand, the pressure control output may or may not change depending on the position of the flow output; and

5. In SOACU, the pressure control output OPp may move gradually to affect the flow valve position so it moves back within the upper bound set at 75%. This demonstrates that its control outputs OP_{f} and OPp act in a coordinated way.

FIG. 12 is a process and instrument diagram illustrating a gas or liquid mixing process control system comprising multiple Self-Organizing Actuation and Control Units (SOACU) according to an embodiment of this invention. This is a general case for controlling a mixed gas or mixed flow process, where there are m flows. The control system comprises m Self-Organizing Actuation and Control Units 170, 172, . . . , 174. Each flow stream comprises a pressure valve, a flow valve, and a pressure transducer.

### Summary

The features and benefits of an SOA and SOACU based control system include:

1. The Self-Organizing Actuation and Control Units (SOACU) are developed based on a general-purpose approach where Model-Free Adaptive (MFA) controllers are used. The solution can effectively deal with large and random flow and pressure disturbances due to sudden changes in the flow supply and demand from the upstream and downstream processes;

2. Using the SOACU technology, the flow in each stream can be effectively controlled, and the differential pressure can be stabilized during disruptive operating conditions. Therefore, the interactions among the flow streams may still exist but are significantly reduced;

3. Since the SOACU allows the flow valves to work in their relatively linear range, valve positioners for the flow valves may not be required. This will result in cost savings;

4. Internal valve positioners can still be designed as part of the SOACU to deal with more difficult control and actuation situations; and

5. Since SOACU incorporates all the instrumentation and actuation devices, this complex system becomes much more concise and easier to implement and maintain.

1. A self-organizing process control system, comprising:
a) a control layer that includes one or multiple automatic controllers for controlling various process variables;
b) a sensing layer that includes one or multiple sensors for measuring various process variables;
c) an actuation layer that includes one or multiple actuators that take control command signals from the controllers and manipulate certain process inputs or manipulated variables;
d) a process layer that includes physical processes or systems with inputs and outputs that have dynamic relationships;
e) one or more of a self-organizing sensor (SOS) and a self-organizing actuator (SOA); and
f) one or more self-organizing actuation and control units (SOACUs).

2. The control system of claim 1, in which f) comprises a multivariable self-organizing actuation and control unit (SOACU).

3. The control system of claim 1, comprising a self-organizing sensor (SOS) characterized by one or more of:
a) having one or multiple inputs from the process layer;
b) having one or multiple inputs from the sensing layer;
c) sending its output to the sensing layer; and
d) sending its output to the control layer.

4. The control system of claim 1, comprising a self-organizing actuator (SOA) characterized by one or more of:
a) taking commands from the control layer;
b) having inputs from the sensing layer; and
c) manipulating one manipulated variable or manipulating multiple manipulated variables in a coordinated way at the same time.

5. The control system of claim 1, comprising a self-organizing actuation and control unit (SOACU) which includes the control layer and the actuation layer and which is characterized by one or more of:
a) having inputs from the sensing layer; and
b) manipulating multiple manipulated variables in a coordinated way at the same time.

6. A self-organizing actuation and control unit (SOACU), comprising:
a) a plurality of controllers;
b) a plurality of valve positioners or damper positioners; and
c) a plurality of control outputs that can work in a coordinated way.

7. The self-organizing actuation and control unit (SOACU) of claim 6, in which one or more of the controllers is a single-input-single-output (SISO) controller.

8. The self-organizing actuation and control unit (SOACU) of claim 6, in which one or more of the controllers is a single-input-single-output (SISO) Model-Free Adaptive (MFA) controller.

9. The self-organizing actuation and control unit (SOACU) of claim 6, in which one or more of the controllers is a multi-input-single-output (MISO) Model-Free Adaptive (MFA) controller.

10. The self-organizing actuation and control unit (SOACU) of claim 9, in which the multi-input-single-output (MISO) Model-Free Adaptive (MFA) controller is a 2-Input-1-Output (2x1) Robust MFA controller, comprising:
a) a primary controller;
b) an upper bound controller;
c) a lower bound controller;
d) an upper bound setpoint setter;
e) a lower bound setpoint setter;
f) a primary process variable and a secondary process variable;
g) an internal setpoint;
h) a plurality of signal adders;
i) a constraint setter;
j) a feedforward MFA controller; and
k) an output combiner that produces a control output.

11. The self-organizing actuation and control unit (SOACU) of claim 10, in which the constraint setter is a limit function f_{c}(•) that combines control outputs of the 2-Input-1-Output (2x1) Robust MFA controller substantially in the following form:
u_{c}(t)=u₁(t), if u(t)>u₁(t)
u_{c}(t)=u(t), if u₂(t)≦u(t)≦u₁(t)
u_{c}(t)=u₂(t), if u(t)<u₂(t)
where u₁(t) is an output of the upper-bound controller, u₂(t) is an output of the lower-bound controller, u(t) is an output of the primary controller, and u_{c}(t) is an output of the limit function f_{c}(•).

12. A fluid mixing process control system, comprising:
a) one or more fluid streams, wherein each of the fluid streams comprises a gas stream or a liquid stream;
b) a self-organizing actuation and control unit (SOACU) for each fluid stream;
c) a pressure control valve and a flow control valve for each fluid stream;
d) a flow sensor for each fluid stream; and
e) a pressure transducer for each fluid stream.

13. The fluid mixing process control system of claim 12, wherein each self-organizing actuation and control unit (SOACU) comprises:
a) a flow controller;
b) a pressure controller;
c) a flow process variable;
d) a differential pressure process variable;
e) a flow control output;
f) a pressure control output;
g) a user selectable flow setpoint for the fluid stream;
h) an internal setpoint for the pressure controller; and
i) an internal feedback signal for the pressure controller.

14. The fluid mixing process control system of claim 12, in which the self-organizing actuation and control unit (SOACU) manipulates the pressure control valve and flow control valve in a coordinated way.

15. The fluid mixing process control system of claim 13, in which each user selectable flow setpoint corresponds to a desirable flow of its corresponding fluid stream.

16. The fluid mixing process control system of claim 13, in which each flow process variable tracks a given trajectory of its corresponding user selectable flow setpoint.

17. The fluid mixing process control system of claim 13, in which the pressure controller of the self-organizing actuation and control unit (SOACU) is a 2-Input-1-Output (2x1) Robust MFA controller, comprising:
a) a primary controller;
b) an upper bound controller;
c) a lower bound controller;
d) an upper bound setpoint setter;
e) a lower bound setpoint setter;
f) a primary process variable and a secondary process variable;
g) an internal setpoint;
h) a plurality of signal adders;
i) a constraint setter;
j) a feedforward MFA controller; and
k) an output combiner that produces a control output.

18. The fluid mixing process control system of claim 17, in which the primary process variable of the pressure controller is the output of the flow controller of the self-organizing actuation and control unit (SOACU).
